(19) United States
(12) Patent Application Publication
(10) Pub. No.: US 2012/0297680 A1
(43) Pub. Date: Nov. 29, 2012

(54) ALLCANDOOR

(76) Inventor: Hsing-Hua KUAN, Taipei (TW)

(21) Appl. No.: 13/426,898

(22) Filed: Mar. 22, 2012

(30) Foreign Application Priority Data
May 26, 2011 (TW) 100209464

(51) Int. Cl. E06B 3/50

(52) U.S. Cl. 49/260

(57) ABSTRACT

A door including a door frame unit, a door leaf, a door closer system and hinges is provided. A sliding groove is opening formed on a top surface or a bottom surface of the door leaf. The door closer system is assembled to the door leaf and the door beam of the door frame (or embedded in the ground). The door closer has a sliding arm, and the sliding arm has a front end pivoted to the sliding groove of the door leaf, and a rear end connected to the door closer. Through the combination of the door closer with the door frame and the door leaf, the door leaf may rotate outward completely or inward with respect to the door columns. Therefore, the elastic stroke and oil pressure efficacy of the door closer is effectively used, to ensure that the door leaf to return to the close state.

### BACKGROUND OF THE INVENTION

1. Field of the Invention

This invention relates to doors, and, more particularly, to an AllCanDoor that has a door controlling system having novel functions.

2. Description of Related Art

Referring to FIG. 1A, a fire door 100 includes a door frame 110, two door leaves 120, and a ground hinge 130.

The door leaves 120 are pivotally connected to the door frame 110 via the ground hinge 130, and rotate at an angle from 0 degree to 180 degrees with respect to the door frame 110.

In the prior art, the axle of the ground hinge 130 rotates at the same angle with the door leaves 120. In other words, if the door leaves 120 are required to be opened until they are parallel with the door frame 110, the axle of the ground hinge 130 must be capable of rotating at 180 degrees.

With regard to another conventional door frame (for example, single action or double action), the sliding arm is about 55-65 mm in length (i.e., a horizontal distance from a vertical surface of an erective frame to a vertical line of the axle of the hinge, referring to FIGS. 1B and 1C) due to the interaction of the door frame and the door leaf, and is set to be 55-65 mm by the manufacturer, for torque and safety reasons. Therefore, the positions of two ends of the sliding arm fixed to the door closer and the door leaf, respectively, are required to be measured accurately. Moreover, the sliding arm of 55-65 in length is not robust enough to be applied to a wider or heavier door frame. In the prior art, a crack between the door leaf and the door frame is as large as 7 cm (refereeing to FIG. 1D). Such a large crack does not please the eyes, and may clamp and harm the fingers.

### SUMMARY OF THE INVENTION

It is an objective of the present invention to provide a novel door that employs the elastic stroke and oil pressure efficacy of a door closer and rotate back to a close state after rotating and being parallel to a door frame.

It is another objective of the present invention to provide a novel door having an increased torque such that it can be applied to a wider or heavier door frame.

It is still another objective of the present invention to provide a novel door, to simplify the measuring process, avoid the assembly failures due to measuring, adjusting and drilling aperture errors, and save assembly labor.

It is yet another objective of the present invention to provide a novel door, allowing a narrower crack to be formed between the door leaf and the door frame and preventing the clamping of fingers by the door leaf.

To achieve the above-mentioned and other objectives, a door is provided according to the present invention, comprising: a door frame unit including a door beam and two door columns that are jointed vertically to two ends of the door beam; at least a door leaf including a top surface, a bottom surface, an inner side surface corresponding in position to one of the door columns of the door frame, and a sliding groove openly formed on the top surface or the bottom surface; a door closer system assembled to the door leaf and the door beam (or ground) and including a door closer, a sliding arm, a sliding track, and a sliding leaf, wherein the sliding track is embedded in the sliding groove of the door leaf, the sliding arm has a front end connected to the sliding leaf and pivoted in the sliding track, and a rear end connected to the door closer, and the door closer is combined with the door beam; at least two hinges assembled between the inner side surface and the door columns, wherein the door leaf rotates outward or inward with respect to the door columns.

Compared with the prior art, in the present invention the axle does not stay at a fixed position, and the axle and the door leaf have different rotation angles. For example, when the door leaf is fully open and parallel to the door frame, the rotation angle of the axle of the door closer is about 160 degrees, with 10% of the elastic stroke and oil pressure efficacy remaining. Accordingly, the remaining elastic stroke and oil pressure efficacy of the door closer are better used, to ensure that the door leaves to return to the close state after being in the fully open state.

In the prior art, the axle distance of the door closer (i.e., a horizontal distance from an erective frame vertical surface to a hinge axle vertical line) is limited to be within 56-65 mm. For example, the axle distance may be set to be 65 mm, depending on practical demands, such as the torque efficacy and the depth of the door frame. By contrast, the axle distance of the door closer according to the present invention is within 66-200 mm. If the axle distance of the door closer according to the present invention is, for example, 150 mm of the moving torque of the sliding arm, the sliding arm rotates the door leaf to be parallel to the door frame, and has a rotation angle less than 180 degrees (e.g., the axle angle of the door closer is about 160 degrees), without interfering with the erective frame of the door frame. The sliding arm has an increased torque, and can be applied to a wider or heavier door frame. Therefore, the present invention can simplify the measuring process, avoid the assembly failures due to measuring, adjusting and drilling aperture errors, and save assembly labor.

In an embodiment, the door closer system is a transom-concealed door closer. Additionally, a variety of hardware may be provided according to the present invention. Accordingly, a novel, invisible, and easy-to-be-assembled door is proposed.

### BRIEF DESCRIPTION OF DRAWINGS

The invention can be more fully understood by reading the following detailed description of the preferred embodiments, with reference made to the accompanying drawings, wherein:

FIG. 1A is a top view of a fire door according to the prior art;

FIG. 1B is a top view of a ground hinge of a fire door according to the prior art;

FIG. 1C is a schematic diagram showing a door frame in operation with a door leaf of a conventional fire door;

FIG. 1D is a schematic diagram showing a sliding arm of a conventional fire door that has two ends fixed to a door closer and a door leaf, respectively;

FIG. 2 is an exploded view of a novel door of a first embodiment according to the present invention;

FIG. 3 is a top view of the first embodiment, in which the door leaves are in a close state;

FIG. 4 is a three-dimensional diagram of a hinge shown in FIG. 2;

FIG. 5 is a three-dimensional diagram of a door closer system and a door leaf shown in FIG. 2;

FIG. 6 is a top view of two door leaves in the first embodiment, in which the door leaves are in an open state and parallel to each other;

FIG. 7 is a partial assembly diagram of a door leaf, a hinge and a door frame, wherein the door leaf is in a close state;

FIG. 8 is a partial assembly diagram of a door leaf, a hinge and a door frame, in which the door leaf is perpendicular to the door frame in a first direction A;

FIG. 9 is a partial assembly diagram of a door leaf, a hinge and a door frame, in which the door leaf is parallel to the door frame in a first direction A;

FIG. 10 is a partial assembly diagram of a door leaf, a hinge and a door frame, in which the door leaf is perpendicular to the door frame in a second direction B;

FIG. 11 is a partial assembly diagram of a door leaf, a hinge and a door frame, in which the door leaf is parallel to the door frame in a second direction B;

FIG. 12 is an exploded view of a novel door of a second embodiment according to the present invention;

FIG. 13 is a top view of the second embodiment, in which the door leaf rotates from a close state to being parallel to the door frame;

FIG. 14 is an exploded view of a third embodiment according to the present invention;

FIG. 15 is an exploded view of a fourth embodiment according to the present invention, in which two double-L-shaped door leaves rotate from a close state to being perpendicular to each other;

FIGS. 16 and 17 are top views of a fifth embodiment according to the present invention, in which an invisible hinge is shown;

FIG. 18 is the implementation of the fifth embodiment, in which two L-shaped door columns rotate from a close state to being parallel to each other;

FIG. 19 is the implementation of the fifth embodiment, in which the two double-L shaped door leaves rotate from a close state to be perpendicular to each other; and

FIG. 20 is a moving torque of the sliding arm of the axle distance of the door closer of an embodiment according to the present invention.

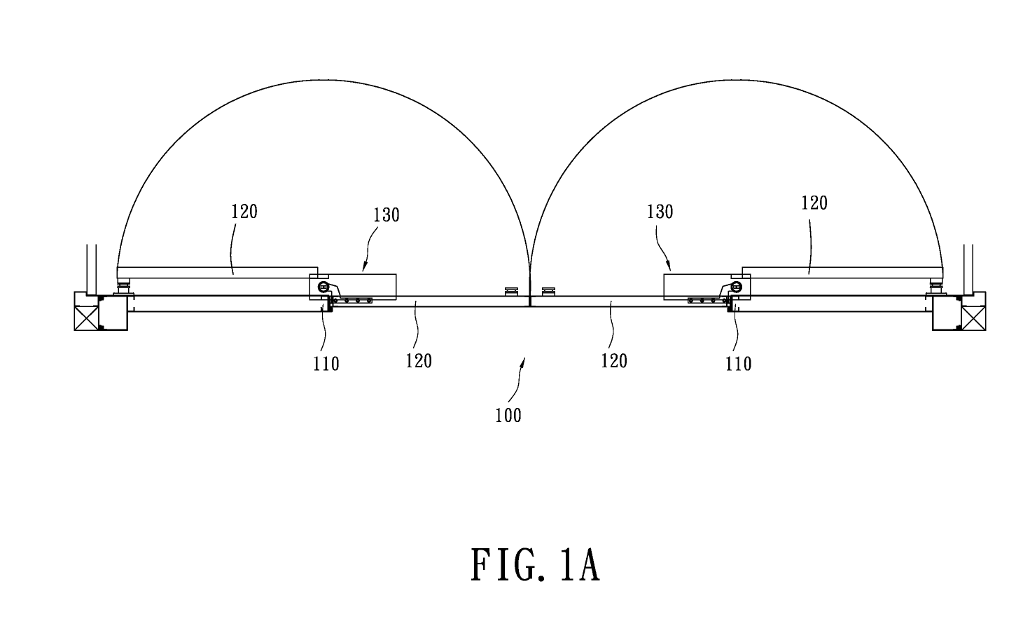

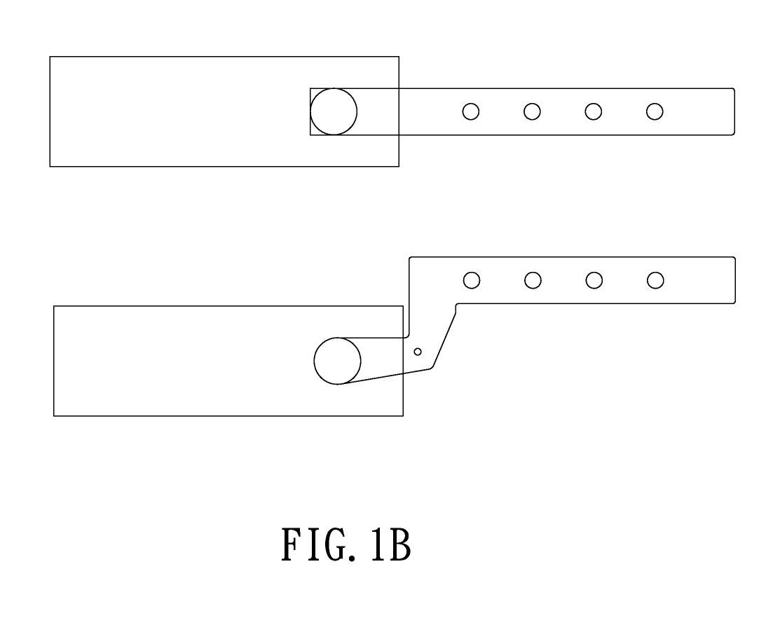

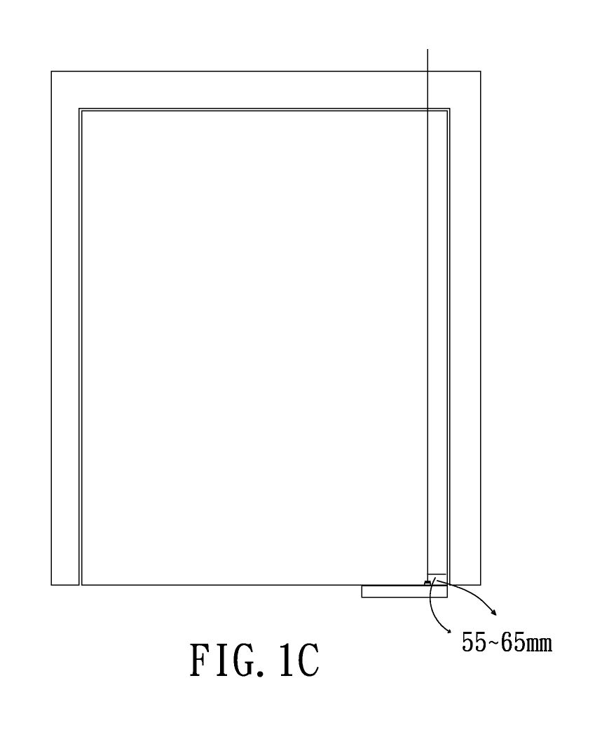

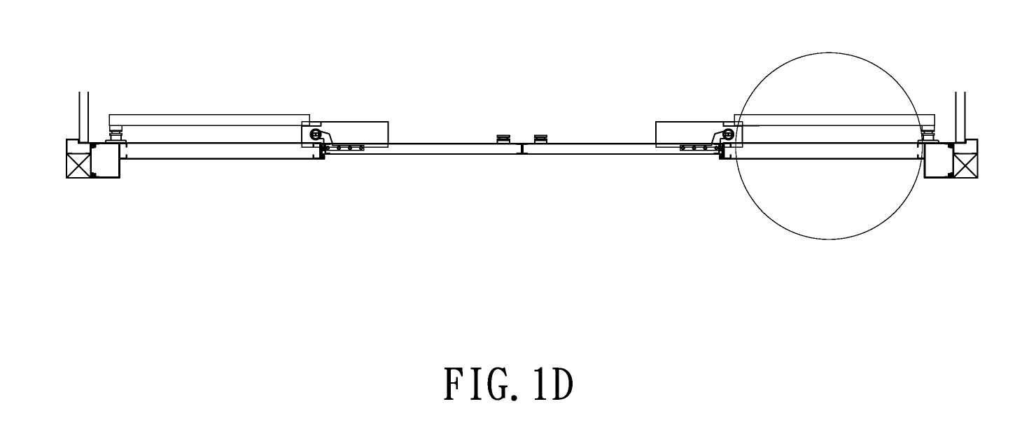

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

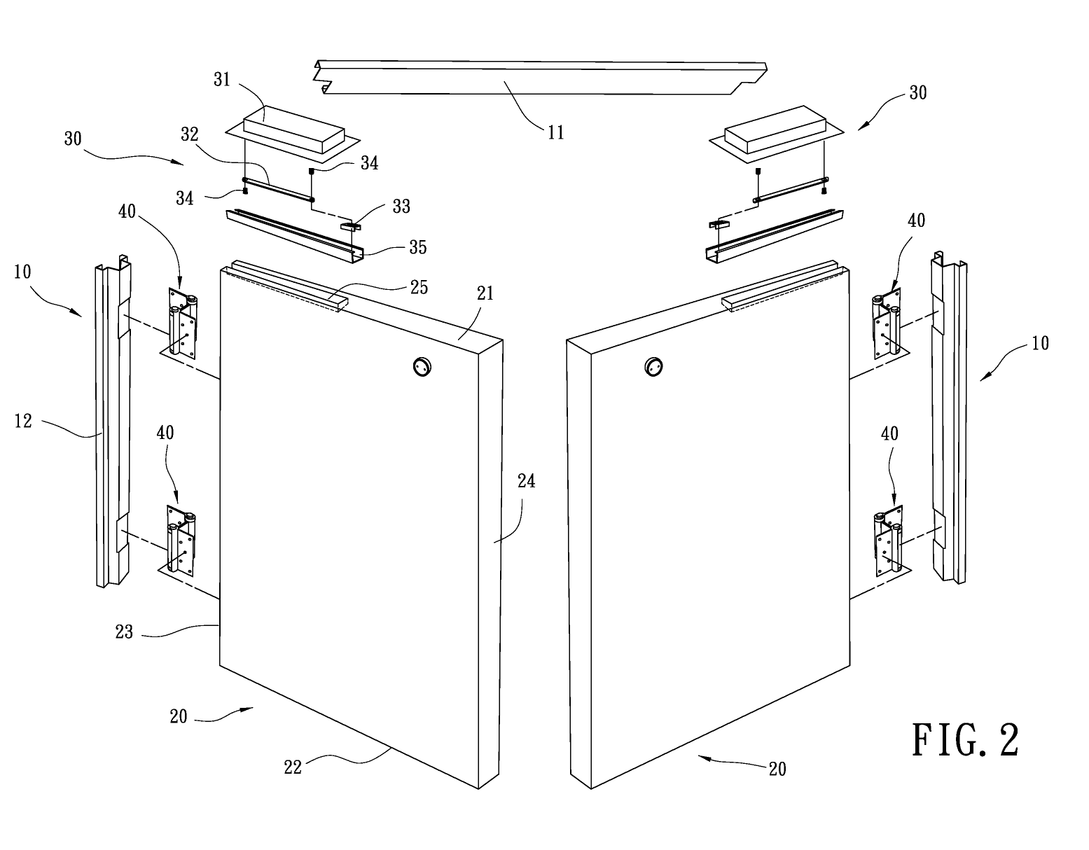

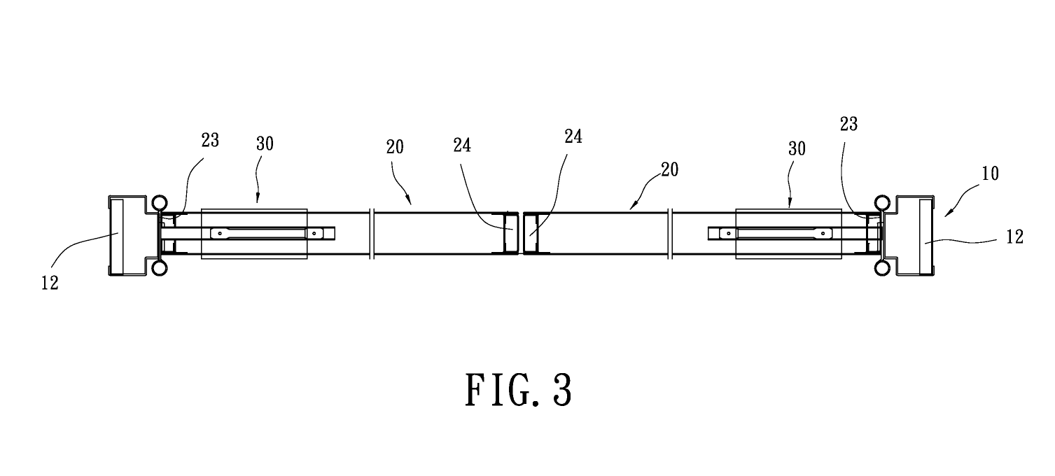

Referring to FIGS. 2 and 3, a novel door (also referred to as a “AllCanDoor”) of a first embodiment according to the present invention is shown. The door comprises a door frame unit 10, two door leaves 20, two door closer systems 30, and four hinges 40.

The door frame unit 10 comprises a door beam 11 and two oppositely disposed door columns 12 that are vertically jointed to two ends of the door beam 11. At least one of the two door columns 12 has a concave, L-shaped or double-L-shaped cross section. For example, both of the two door columns 12 have the double-L-shaped cross section, and the concave portions of the double-L-shaped cross sections are face-to-face.

Each of the door leaves 20 has a top surface 21, a bottom surface 22, an inner side surface 23, an outer side surface 24, and a sliding groove 25.

The sliding groove 25 may be formed on the top surface 21 or the bottom surface 22. In the first embodiment, the sliding groove 25 is formed on the top surface 21. The inner side surface 23 of each of the door leaves 20 corresponds in position to the door columns 12 of the door frame unit 20. When the door leaves 20 are in a close position, the outer side surfaces 24 of the two door leaves 20 are face-to-face.

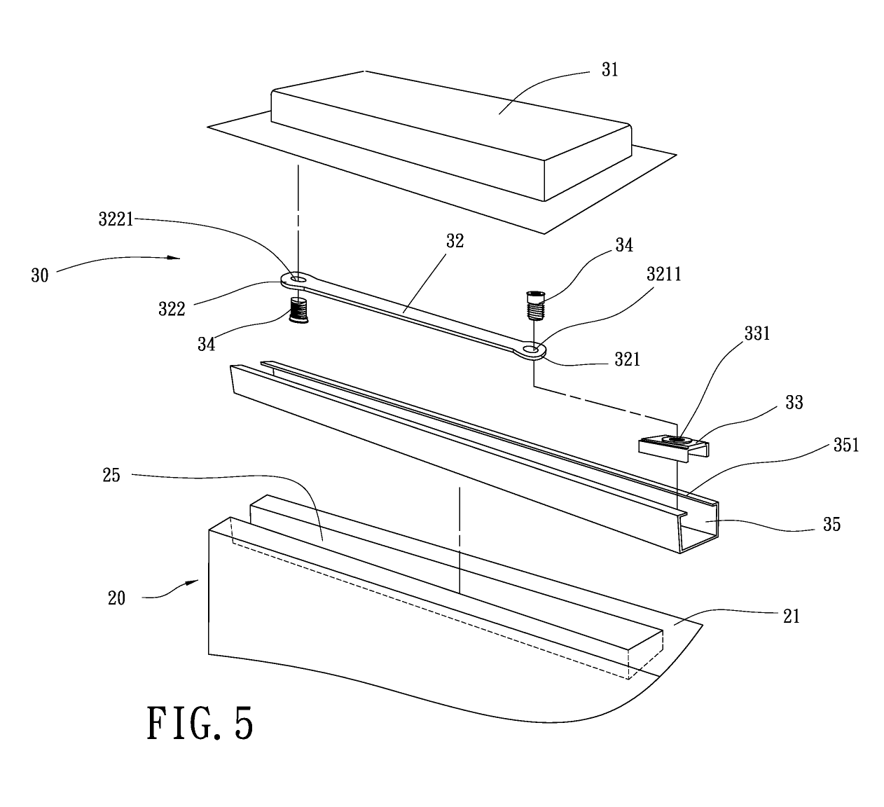

Referring to FIGS. 2 and 5, the door closer systems 30 are installed between the door leaves 20 and the door beam 11 (or ground). Each of the door closer systems 30 comprises a door closer 31, a sliding arm 32, a sliding leaf 33, a pin connection member 34 and a sliding track 35. In the first embodiment, the door closer systems 30 correspond in position to the sliding grooves 25 and are installed on the top surfaces 21 of the door leaves 20, respectively, and assembled with the door beam 11. Each of the sliding leaves 33 has an aperture 331. Preferably, each of the sliding leaves 33 has an open-rectangle-shaped structure. Each of the sliding tracks 35 has an inward protrusive elongated flange 351 disposed on a top end thereof such that the groove radius of the top end of the sliding track 35 is reduced. Each of the sliding arms 32 comprises a front end 321 and a rear end 322. The front end 321 has a front aperture 3211, and the rear end 322 has a rear aperture 3221, allowing the pin connection member 34 to pass therethrough and be connected to the aperture 331 of the sliding leaf 33 and the door closer 31, to form an active hinging structure.

The sliding track 35 is embedded in the sliding groove 25 of the door leaf 20. The pin connection member 34 passes through the aperture 3211 of the front end 321, is hinged to the aperture 331 of the sliding leaf 33, and is pivoted to the sliding track 35. The elongated flange 351 of the sliding track 35 is hooked to the sliding leaf 33, allowing the sliding leaf 33 to move in the sliding track 35. The rear end 322 of the sliding arm 32 is hinged to the door closer 31 and combined with the door beam 11. The movement of the sliding arm 32 enables the sliding leaf 33 to form in the sliding track 35 a pivot point P that moves back and forth.

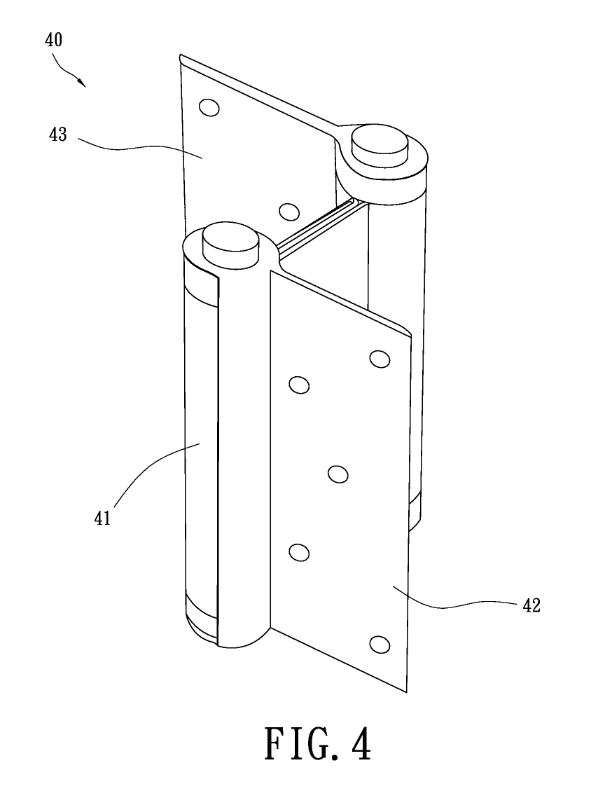

Referring to FIGS. 2 and 4, the hinges 40 are installed between the inner side surfaces of the door leaves 20 and the door columns 12 of the door frame unit 10. Through the installation of the hinges 40 and the door closer system 30, the door leaves 20 may rotate outward or inward with respect to the door columns 12. The hinges 40 in FIGS. 2-4 are preferably a double action hinges that cooperate with the concave door columns 12 and the door leaves 20, allowing the door leaves 20 to rotate 360 degrees, as described in the following paragraphs

Each of the double action hinges 40 comprises two hinge bodies 41, a first pivoting leaf 42 pivoted to one of the hinge bodies 41, and a second pivoting leaf 43 pivoted to the other of the hinge bodies 41. The first pivoting leaf 42 and the second pivoting leaf 43 have a plurality of locking apertures disposed thereon. FIG. 4 does not show the locking aperture of the second pivoting leaf 43, for brevity.

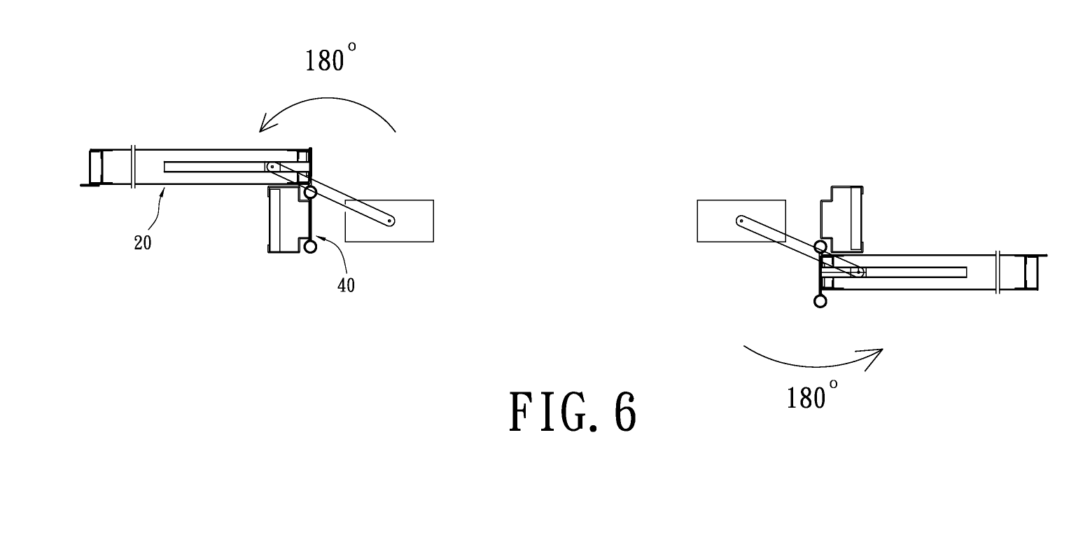

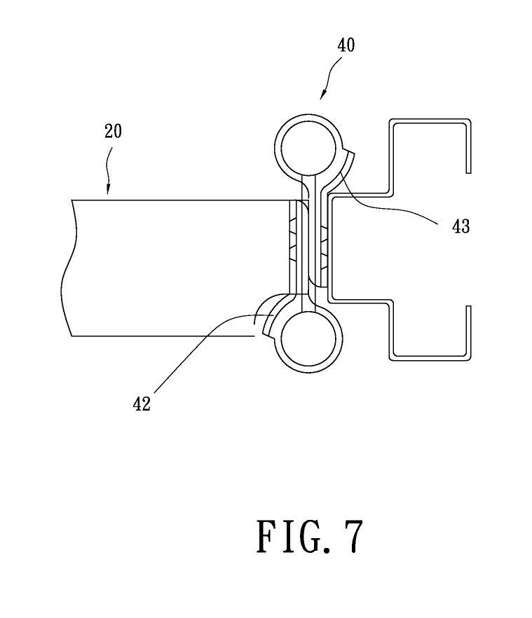

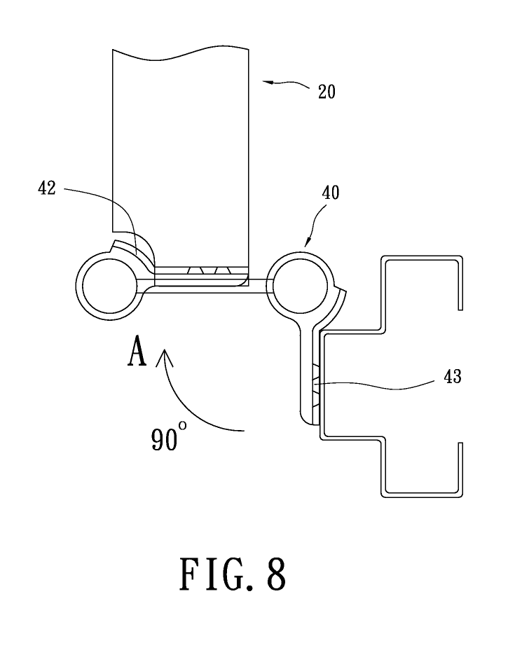

Referring to FIGS. 6-8, the door leaves 20 rotate from a close state shown in FIG. 7 to being perpendicular to each other in a first direction A. The first pivoting leaves 42 of the hinges 40 are away from the second pivoting leaves 40 and are in a 90-degree state, in which the door leaves 20 rotate in the first direction A and are perpendicular to each other.

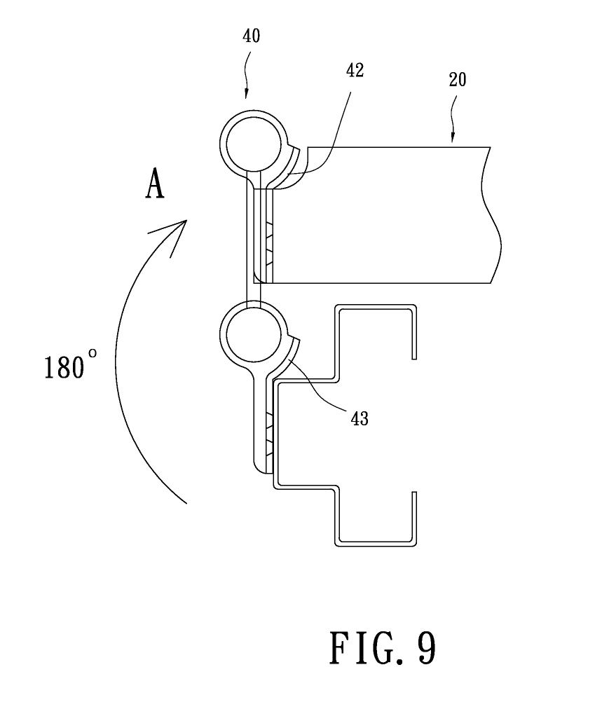

Referring to FIG. 9, the door leaves 20 rotate continuously in the first direction A and are perpendicular to each other. The first pivoting leaves 42 of the hinges 40 are away from the second pivoting leaves 43 and are in a 180-degree state. The door leaves 20 rotate in the first direction A and are parallel to each other.

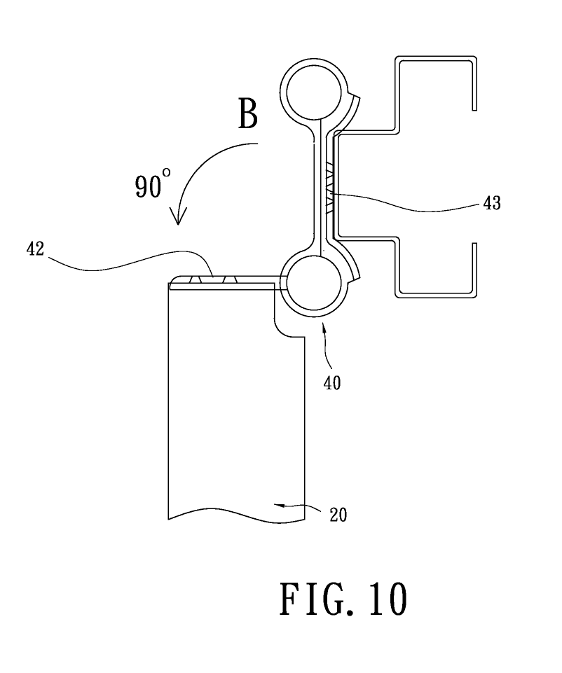

Referring to FIGS. 6, 7 and 10, the door leaves 20 rotate from a close state shown in FIG. 7 in a second direction B to being perpendicular to each other. The first pivoting leaves 42 of the hinges 40 are thus away from the second pivoting leaves 43 and are in a 90-degree state. The door leaves 20 rotate in the second direction B and are perpendicular to each other.

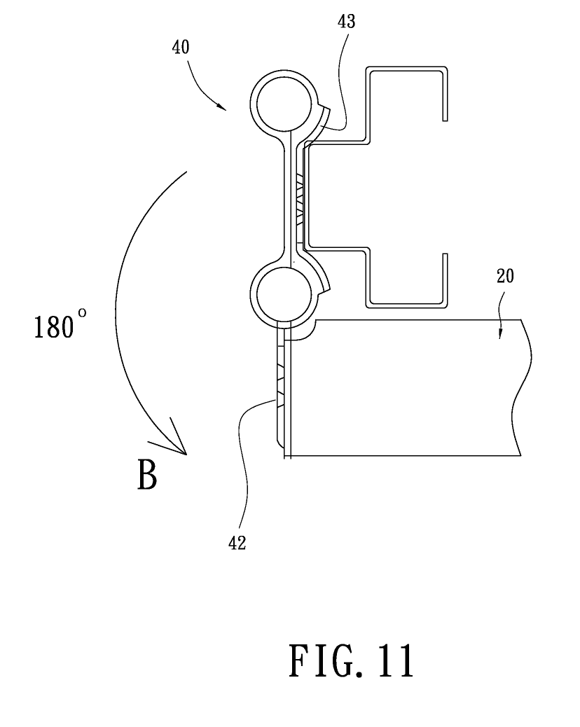

Referring to FIG. 11, the door leaves 20 rotate continuously in the second direction B and are perpendicular to each other. The first pivoting leaves 42 of the hinges 40 are thus away from the second pivoting leaves 43 and are in a 180-degree state. The door leaves 20 rotate in the second direction B and are parallel to each other.

It is known from the above that the door leaves 20 may rotate in the first direction A and the second direction B, and are parallel to each other by the movement of the door closer system 30 with the sliding arm and the engagement of the hinges 40 with the door frame unit 10 and the door leaves 20. Accordingly, the door leaves 20 may rotate in a 360-degree state and be fully opened.

In the above-mentioned embodiments, the double action hinges 40 in operation with the door closer may provide high efficiency by the adjustment of the axle distance. Moreover, the double action hinge and the door closer system enhance the carrying capability of the door leaves, and a larger or heavier door frame may thus be employed.

The door leaves 20, when rotating, are not hooked to any dead spot of the door leaves 20. Accordingly, the hinges 40 rotate vertically in a 360-degree rotation angle manner. The hinges 40 do not interfere with the door closer system 30 and are complementary to the door closer system 30.

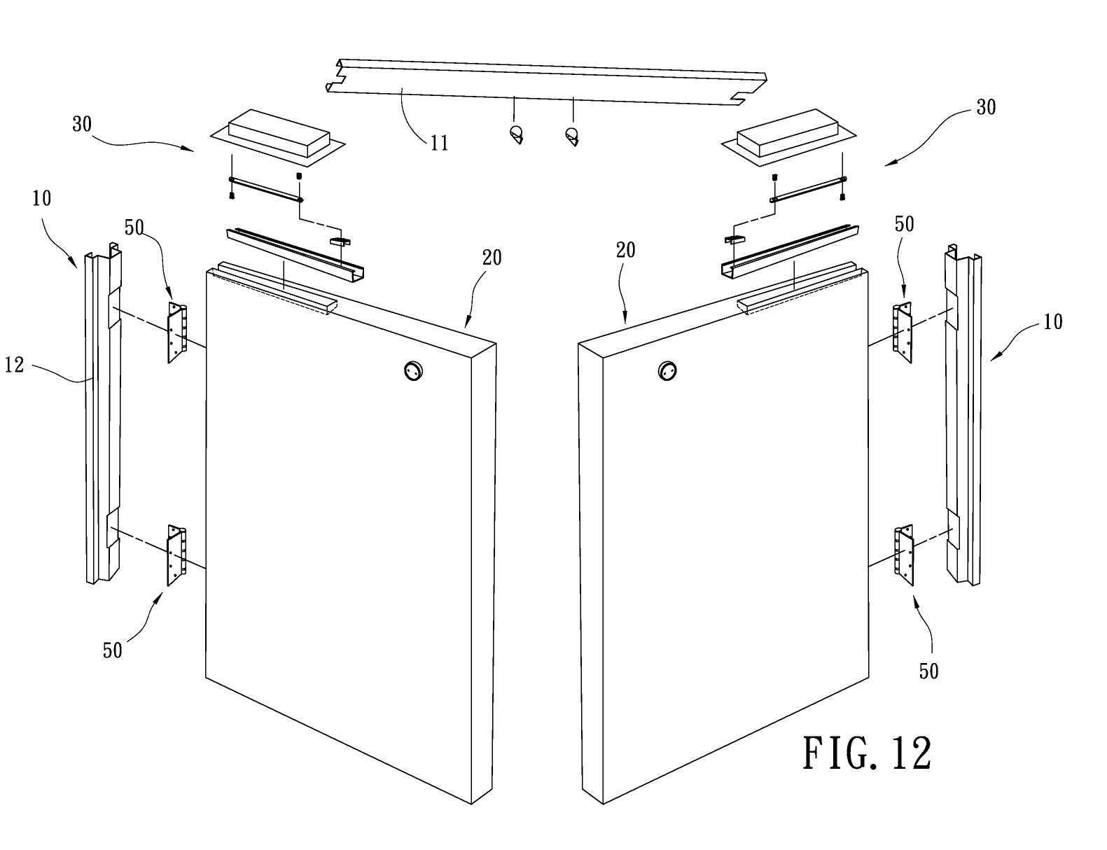

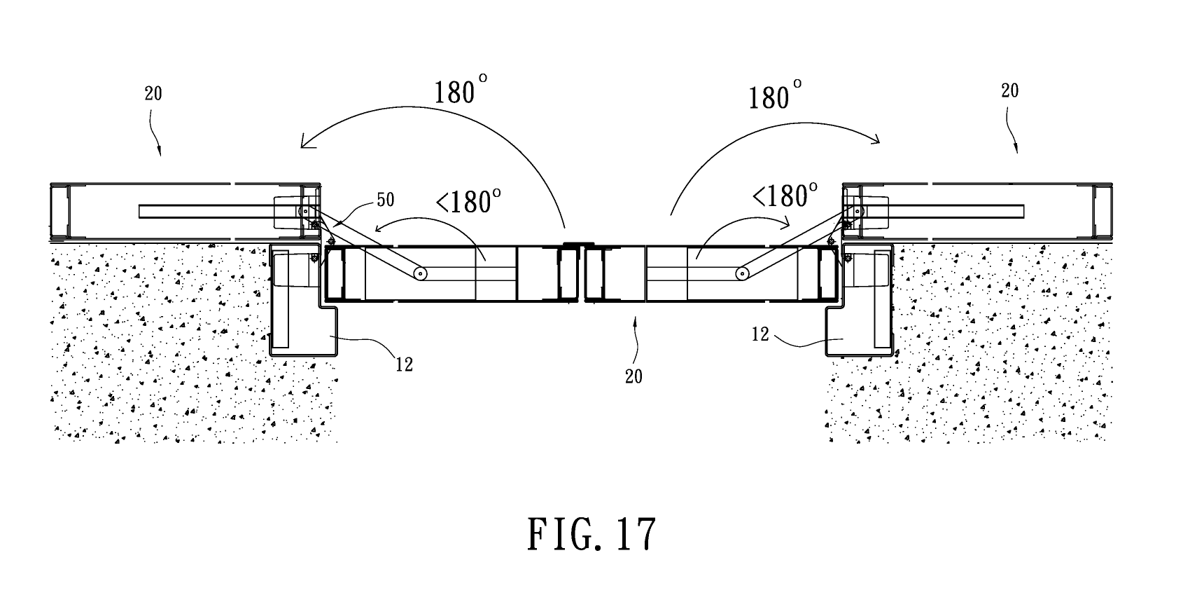

Referring to FIGS. 12-20, a novel door of second, third, fourth and fifth embodiments are provided according to the present invention. The novel door comprises a door frame unit 10, two door leaves 20, a door closer system 30 and four hinges 50.

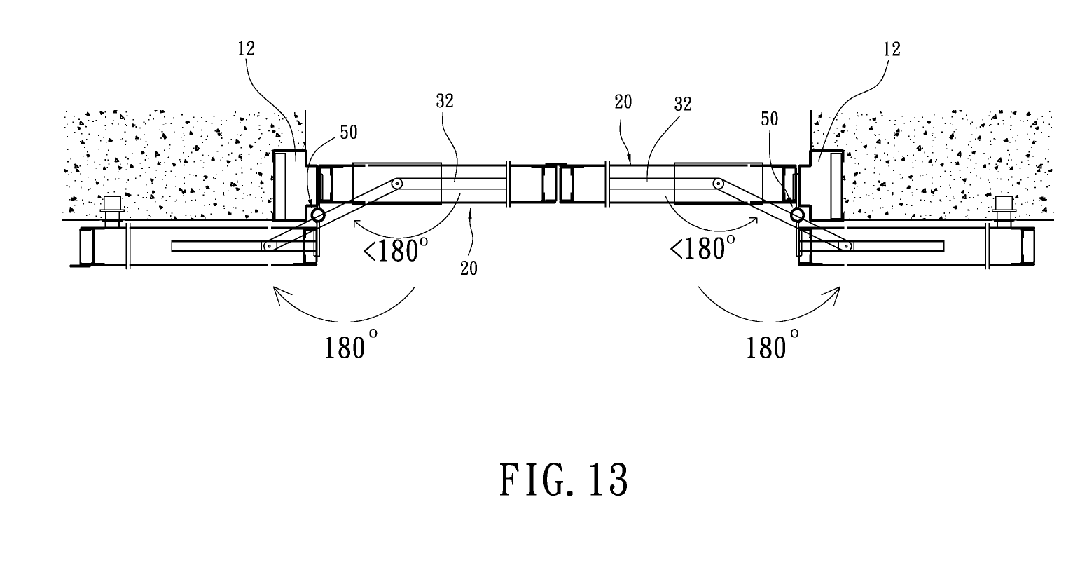

In the second embodiment shown in FIGS. 12 and 13, the door frame unit 10, the door leaves 20 and the door closer system 30 have the same structures as the first embodiment shown in FIG. 2, further description thereof hereby omitted.

Preferably, the hinges 50 in the second embodiment are a single action hinge, which cooperates with the concave door columns 12 and the door leaves 20, allowing the door leaves 20 to rotate and be parallel to the door frame.

The second embodiment achieves the same efficacy as the first embodiment. Preferably, the door closer system is a transom-concealed door closer, and the door leaves 20 rotate and are parallel to the door frame by utilizing the single action hinge 50.

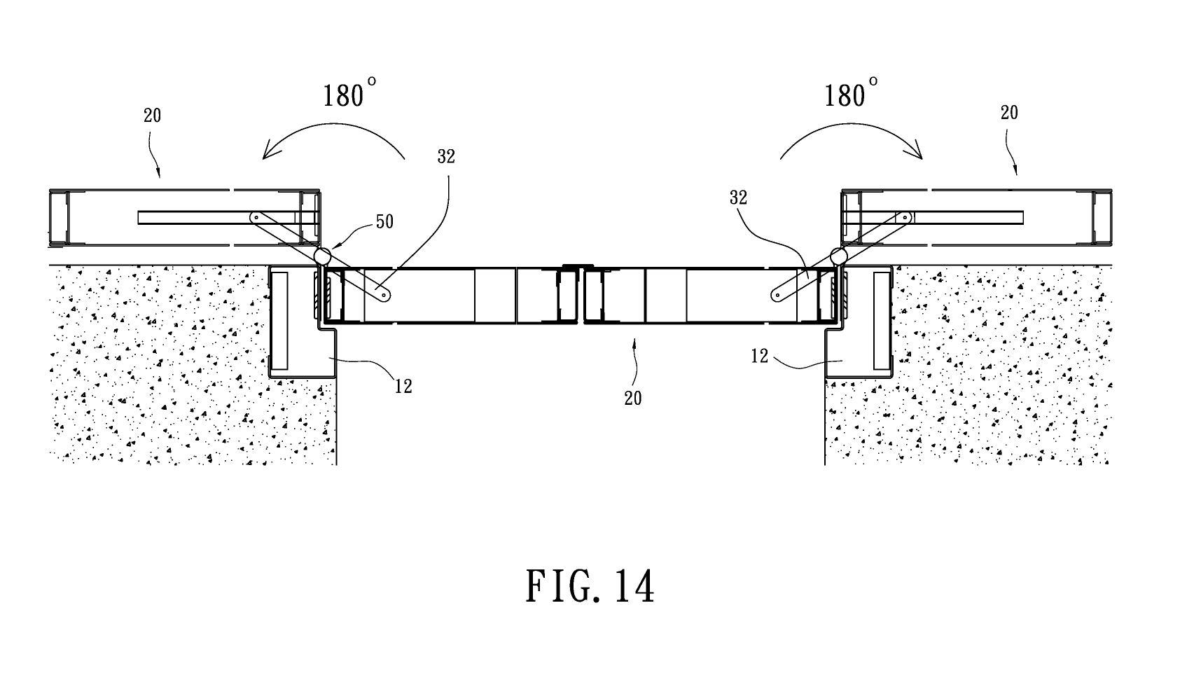

Referring to FIG. 14, the hinge 50 of the third embodiment is preferably a single action hinge, and the door of the door frame 10 is an L-shaped door column 12 that is connected to the hinge 50 and the door leaves 20, allowing the door leaf 20 to rotate and be parallel to the door frame 10. The door closer system 30 and the door leaves 20 in the third embodiment are the same as the first and second embodiments.

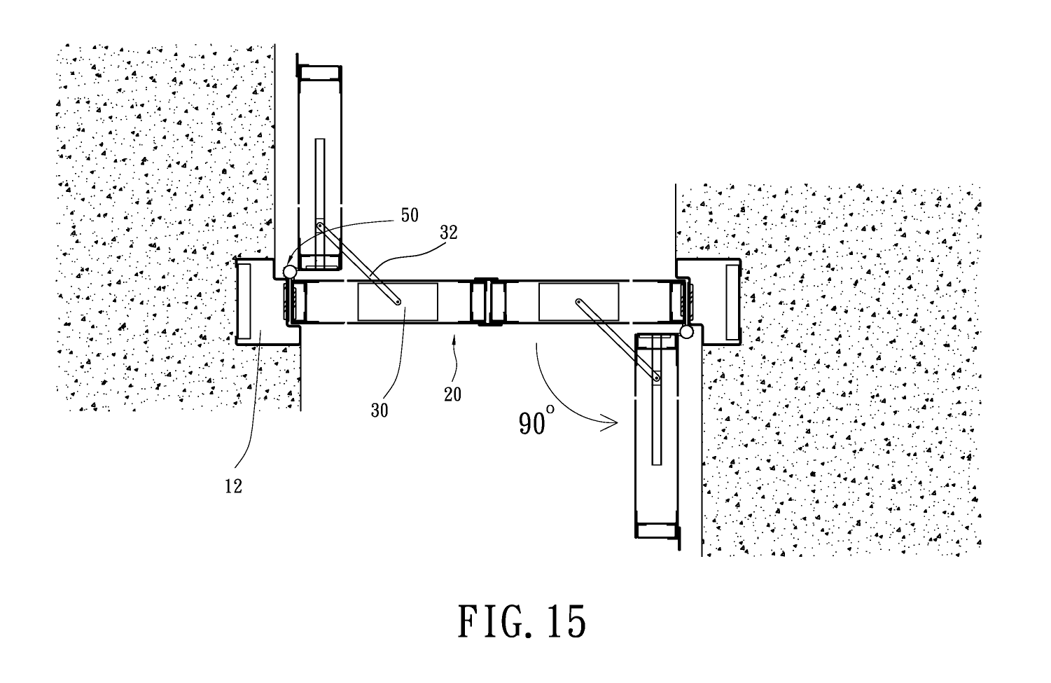

Referring to FIG. 15, the hinge 50 of the fourth embodiment is preferably a single action hinge that cooperates with the double-L-shaped door column 12 and the door leaves 20, allowing the door leaf 20 to rotate and be perpendicular to the door frame 10. A partial of the openings of the double-L-shaped door columns 12 are reversely disposed correspondingly. By using a second L-shaped structure of the double-L-shaped door column 12 in an open direction, the hinges 50 and the door leaves 20 are provided with more space. A partial of the openings of the door columns 12 are reversely disposed correspondingly, allowing the two door leaves 20 to open reversely and be perpendicular or parallel to each other. Therefore, users may run out of a building in two directions because both of the two door leaves may be opened.

In the fourth embodiment, the door closer system is preferably a transom-concealed door closer, and the remaining elements are the same as the first to third embodiments.

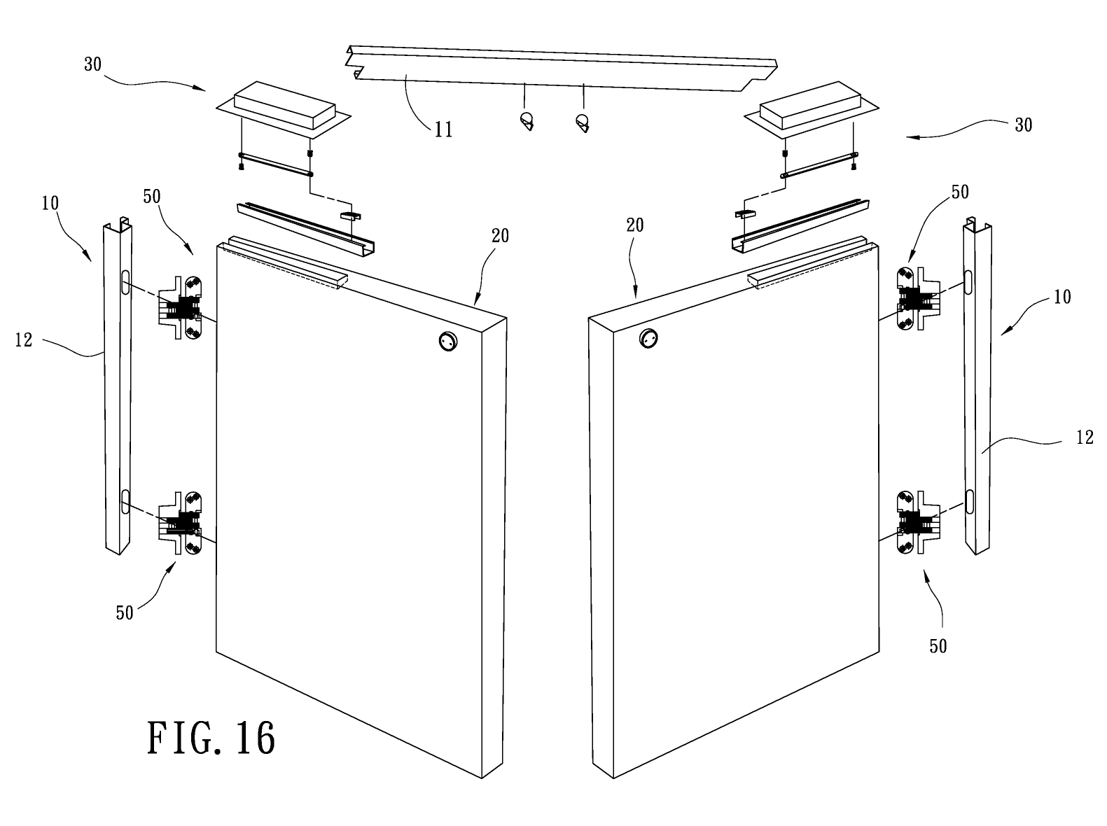

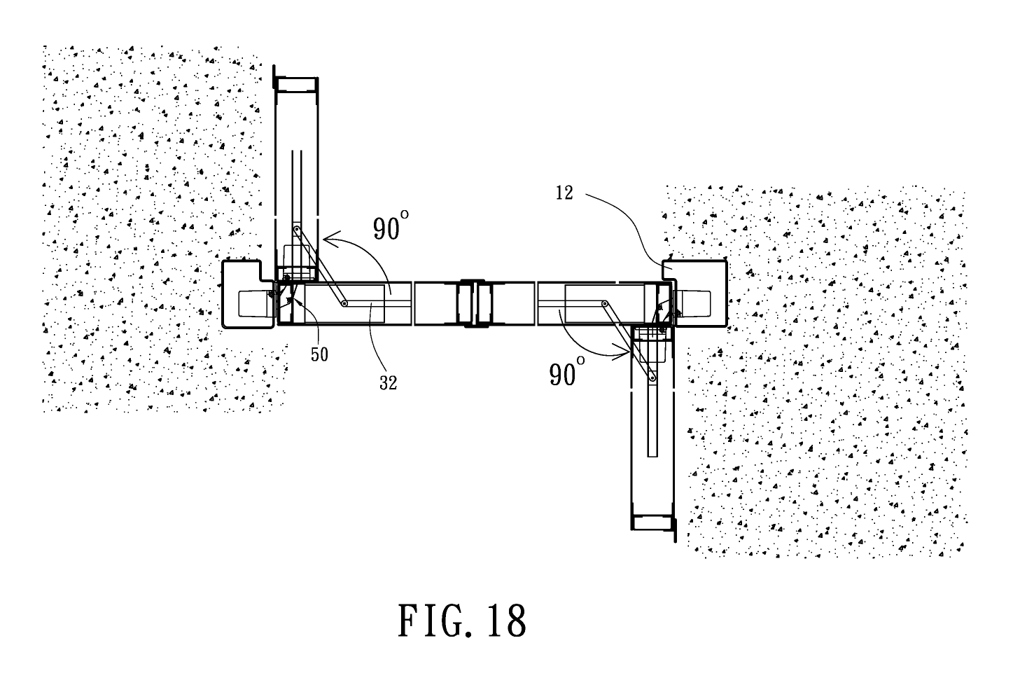

Referring to FIGS. 16-18, the hinges 50 in the fifth embodiment are invisible single action hinges that cooperate with the L-shaped door columns of the door frame 10 that are connected to the hinges 50 and the door leaves 20, allowing the door leaves 20 to rotate and be parallel to the door frame. Preferably, the door closer system 30 is a transom-concealed door closer, and the door leaves 20 of the fifth embodiment are the same as the first to fourth embodiments. Referring to FIG. 18 at the same time, in another embodiment the invisible hinge cooperates with the double-L-shaped door columns 12 and the door leaves 20, allowing the door leaf 20 to rotate and be parallel or perpendicular to the door frame 10. A portion of the openings of the double-L-shaped door columns 12 are reversely disposed correspondingly. By using the second L-shaped structure of the double-L-shaped door column 12 in the opening direction, the hinges 50 and the door leaves 20 are provided with more space, and a portion of the openings of the double-L-shaped door columns 12 are reversely disposed correspondingly, allowing the two door leaves 20 to open reversely and be perpendicular or parallel to each other. Therefore, users may run out of a building in two directions because both of the two door leaves may be opened.

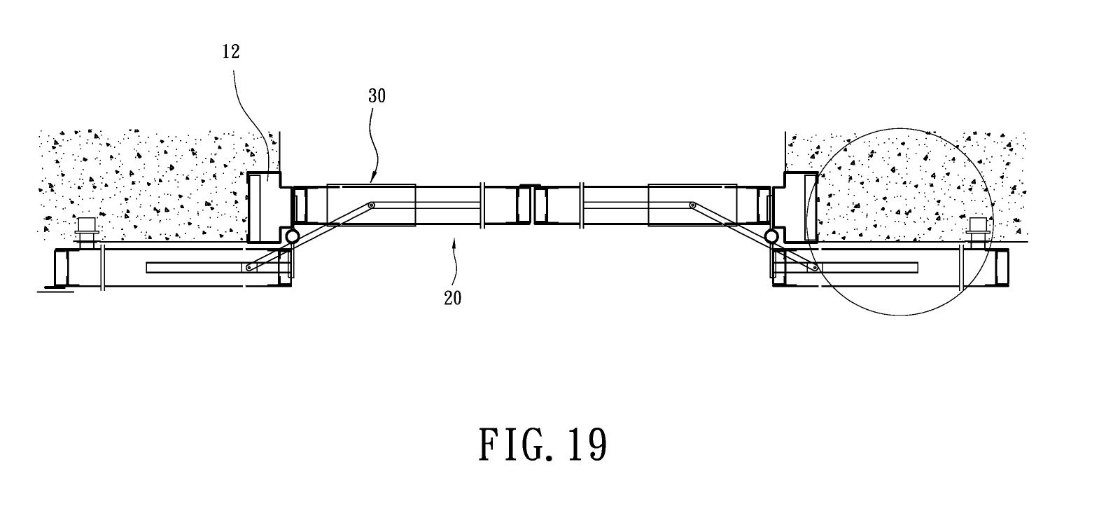

Refer to FIG. 19. In the fifth embodiment, since the two ends of the invisible hinge are embedded in the L-shaped door column 12 and the door leaves 20, the crack G is as narrow as 1 cm. In comparison with the conventional door having a crack of 7 cm, the door according to the present invention has a smaller crack, avoiding the clamping of fingers by the door leaves 20.

In conclusion, the axle rotation angle of the door closer 31 is less than the opening angle of the door leaf 20, as shown in FIG. 6, in which the door leaves 20 rotate and are parallel to the door frame, and the axle rotation angle of the door closer 31 is 160 degrees, with about 10% of elastic stroke and oil pressure efficacy remaining. Therefore, the axle rotation angle of the door closer 31 is less than the opening angle of the door leaf 20. Accordingly, the remaining elastic stroke and oil pressure efficacy of the door closer 31 are better used, to ensure that the door leaves 20 to return to the close state after being in the fully open state.

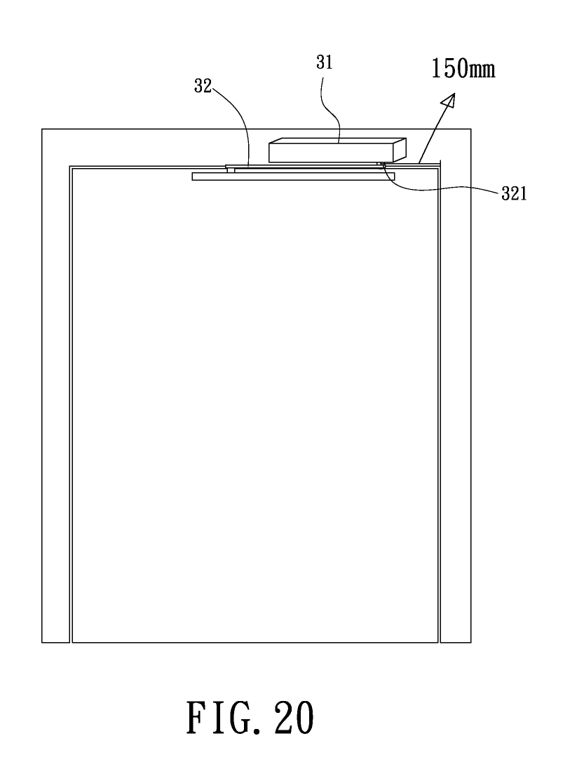

Referring to FIGS. 20 and 5, the axle distance of the door closer 31 is about a moving torque of the sliding arm of 150 mm (i.e., a horizontal distance from an erective frame vertical surface to a hinge axle vertical line). Compared to the convention door frame axle distance of 55 mm to 65 mm, the axle rotation angle of the door closer 31 according to the present invention is less than the opening degree of the door leaf 20, which thus does not interfere with the door frame erective frame. Moreover, the sliding arm 32 has an increased torque, allowing the operation of a wider or heavier door frame. Since the sliding arm 32 may move in the sliding groove, the front end 321 of the sliding arm 32 on the door closer 31 is pivoted in the sliding groove 25 of the top surface 21 of the door leaf 20. Therefore, it is not necessary to measure accurately the aperture 3211 of the front end 321 of the sliding arm 32 on the door closer 31, and the assembly failure due to the aperture measuring errors is avoided. Therefore, the present invention can simplify the measuring process, avoid the assembly failures due to measuring, adjusting and drilling aperture errors, and save assembly labor.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A door, comprising:
a door frame unit including a door beam and two door columns that are jointed vertically to two ends of the door beam;
at least a door leaf including a top surface, a bottom surface, an inner side surface corresponding in position to one of the door columns of the door frame, and a sliding groove openly formed on the top surface or the bottom surface;
a door closer system assembled to the door leaf and the door beam (or ground) and including a door closer, a sliding arm, a sliding track, and a sliding leaf, wherein the sliding track is embedded in the sliding groove of the door leaf, the sliding arm has a front end connected to the sliding leaf and pivoted in the sliding track and a rear end connected to the door closer, and the door closer is combined with the door beam;
at least two hinges assembled between the inner side surface and the door columns,
wherein the door leaf rotates outward or inward with respect to the door columns.

2. The door of claim 1, wherein the door closer system further comprises a pin connection member, the sliding leaf comprises a first aperture, and the front end or the rear end of the sliding arm comprises a second aperture, allowing the pin connection member to pass through the first aperture to connect the second aperture with the door closer.

3. The door of claim 1, wherein the at least two hinges comprise a double-action hinge.

4. The door of claim 3, wherein the double-action hinge includes two hinge bodies, a connection leaf connected to the hinge bodies, a first pivoting leaf pivoted to one of the hinge bodies and having a plurality of first locking apertures, and a second pivoting leaf pivoted to the other of the hinge bodies and having a plurality of second locking apertures.

5. The door of claim 1, wherein the door columns are concave or L-shaped door columns, and the hinges include a single-action hinge in cooperation with the concave or L-shaped door columns and the door leaf.

6. The door of claim 5, wherein the hinges include an invisible hinge.

7. The door of claim 5, wherein the door closer system is a transom-concealed door closer.

8. The door of claim 7, wherein the door closer has an axle rotation angle less than a rotation angle of the door leaf.

9. The door of claim 7, wherein the door closer has an axle distance within 66 mm-200 mm.

10. The door of claim 1, wherein the door columns are double-L-shaped door columns having corresponding openings reversely disposed, and the hinges include a single hinge combined with the door columns such that the door leaf rotates reversely.

11. The door of claim 10, wherein the hinges include an invisible hinge.

12. The door of claim 10, wherein the door closer system is a transom-concealed door closer.
